(19) United States
(12) Patent Application Publication
(10) Pub. No.: US 2019/0033476 A1
(43) Pub. Date: Jan. 31, 2019

(54) METHOD AND SYSTEM FOR FORECASTING EARTHQUAKES AND GENERATING EARTHQUAKE ALERTS

(71) Applicants: Robert T. O'Malley, Corvallis, OR (US); Debashis Mondal, Corvallis, OR (US)

(72) Inventors: Robert T. O'Malley, Corvallis, OR (US); Debashis Mondal, Corvallis, OR (US)

(73) Assignee: Oregon State University, Corvallis, OR (US)

(21) Appl. No.: 16/045,648

(22) Filed: Jul. 25, 2018

Related U.S. Application Data
(60) Provisional application No. 62/537,856, filed on Jul. 27, 2017.

(51) Int. Cl. G01V 1/00; G08B 21/10; G06N 7/00; G06F 17/17

(52) U.S. Cl. CPC G01V 1/008; G06F 17/17; G06N 7/00; G08B 21/10

(57) ABSTRACT

A method and system are disclosed for demonstrating a completely new statistical association between earthquake events, for determining spatially-dependent increases in risk levels following a primary earthquake event, and for generating and disseminating alerts accordingly. A time window after a primary earthquake event is chosen. Observed earthquakes within the time window are compared with baseline rates of earthquake events. The observed events are statistically analyzed against pure chance to determine a statistical association between primary earthquakes and follow-on earthquakes. Increases in earthquake risk are determined for multiple spatial zones. Responsive to a primary event, spatially dependent probabilities of a follow-on earthquake, or risk increases, are determined and used to generate and disseminate corresponding alerts. A system comprising seismic sensors, a computing apparatus, and subscriber nodes is described. Variants are disclosed.

### CROSS REFERENCE TO RELATED APPLICATION

This application claims the benefit of U.S. Provisional Application No. 62/537,856, filed on Jul. 27, 2017, the content of which is incorporated herein by reference in its entirety.

### FIELD

The present disclosure concerns a method and system for forecasting increases in earthquake risk, generating corresponding earthquake alerts, and/or transmitting the alerts.

### BACKGROUND

Earthquakes occur frequently and can cause significant damage and loss of life. According to the United States Geological Survey (USGS), earthquakes of magnitude at least 7.0 occur about 18 times in an average year, worldwide. Smaller earthquakes are much more frequent. Many densely populated areas worldwide are located proximate to seismically active regions. Post-earthquake tsunami damage can extend well beyond quake-prone areas.

Earthquake prediction has tremendous potential to alleviate both physical damage and loss of life. However, present early warning systems are merely based on the fact that electromagnetic signals propagate much faster than seismic waves, so that a warning from near the epicenter of an earthquake can reach a far-away location before shaking begins at the far-away location. That is, present early warning systems can only warn of an earthquake that has already occurred. Furthermore, the amount of warning time at nearby locations is minimal and may be only a few seconds.

Accordingly, there remains ample opportunity for an improved method and system for determining earthquake risk, determining increases in earthquake risks, generating earthquake alerts, and disseminating earthquake alerts. There is a particular need for technology that can provide a warning or alert for an earthquake before it occurs.

### SUMMARY

A basic premise of earthquake science is that earthquakes of significant size are independent of each other in space and time, if aftershocks are excluded. In brief, the new technology disclosed herein demonstrates a completely new statistical association between earthquake events, provides a determination of spatially-dependent increases in risk levels following a primary earthquake event, and provides for distribution of alerts accordingly.

In a first aspect, a method is provided for determining enhanced earthquake risk using an archive of historical seismological observations. In embodiments, statistical analysis is performed to determine whether the number of earthquakes observed within a time window following a primary earthquake event can be explained by chance. Matching sets of space-time bins are configured relative to the space-time locations of each of a set of primary earthquake events. A corpus of earthquake event data is grouped into these space-time bins for every primary event. Observed events are counted within the time window, and other time intervals are used to count baseline events. Observed event rates and baseline event rates are used to evaluate p-values for a null hypothesis which corresponds to independence between primary events and observed events. Based on the p-values, the null hypothesis can be accepted or rejected; rejection of the null hypothesis is a demonstration of increased risk of another earthquake within the time window of a primary earthquake. In embodiments, spatial zones are analyzed separately, and the enhancement of earthquake risk can be determined according to the spatial zone.

In a second aspect, a method is provided for generating and disseminating earthquake alerts in response to a primary earthquake event. In embodiments, an indication of a primary earthquake event is received at a first spatial location and at a first time. Based at least in part on this indication, a probability, a probability density, and/or risk enhancement is determined for occurrence of a follow-on earthquake, particularly at a second spatial area, for a second time window relative to the first time. Based at least partly on the probability, probability density, and/or risk enhancement of the follow-on earthquake, an earthquake alert is generated, such as for a second spatial area and a second time window. The earthquake alert can be transmitted to a government agency, a news organization, a website, a subscriber node, or other destination.

In other embodiments, a system is provided comprising a network of one or more seismic sensors, a computing environment configured to generate and transmit earthquake alerts, and one or more subscriber nodes configured to receive earthquake alerts. The computing network can be connected to the seismic sensors by one or more input networks, and can be connected to the subscriber nodes by one or more output networks.

The innovations can be implemented as part of one or more methods, as part of one or more computing systems adapted to perform an innovative method, or as part of non-transitory computer-readable media storing computer-executable instructions for causing a computing system to perform the innovative method(s). The various innovations can be used in combination or separately.

The foregoing and other objects, features, and advantages of the invention will become more apparent from the following detailed description, which proceeds with reference to the accompanying figures.

### BRIEF DESCRIPTION OF THE DRAWINGS

FIG. 1 is a flowchart of a first exemplary method for determining enhancement of earthquake risk according to the disclosed technology.

FIGS. 2A-2E are a series of diagrams illustrating an application of the disclosed technology.

FIGS. 3A-3D are a first set of graphs of relative rates and p-values versus distance from epicenter (in degrees), showing results of analysis of earthquake events according to the disclosed technology.

FIGS. 4A-4B depict a flowchart of a second exemplary method for determining enhanced earthquake risk according to the disclosed technology.

FIG. 5 is a second graph of relative rates and fitted risk enhancement versus distance from epicenter (in degrees), showing results of analysis of earthquake events according to the disclosed technology.

FIGS. 6A-6C are a set of diagrams illustrating spatial and temporal relationships of a cascade of earthquake events determined according to the disclosed technology.

FIG. 7 is a flowchart of an exemplary method for generating an earthquake alert according to the disclosed technology.

FIG. 8 is a diagram depicting an exemplary system for generating and disseminating earthquake alerts according to the disclosed technology.

FIG. 9 is a diagram schematically depicting a computing environment suitable for implementation of the disclosed technology.

### DETAILED DESCRIPTION

### I. Terms

The following explanations of terms are provided to better describe the present disclosure and to guide those of ordinary skill in the art in the practice of the present disclosure. Unless explained otherwise, all technical and scientific terms used herein have the same meaning as commonly understood to one of ordinary skill in the art to which this disclosure belongs. Although methods and apparatus similar or equivalent to those described herein can be used in the practice or testing of the present disclosure, suitable methods and apparatus are described below. The apparatus, methods, and examples are illustrative only and not intended to be limiting. Other features of the disclosure are apparent from the following detailed description and the claims.

Aftershock: An aftershock is an earthquake that occurs after another earthquake and in the same fault zone. If an aftershock is stronger than its predecessor, it is commonly relabeled as the main quake, and the predecessor is labeled as a foreshock. Aftershocks commonly occur within minutes to days after a main quake, but can in certain circumstances occur months or years later. A quake and its aftershock(s) can sometimes be distinguished from independent events based on the presence of elevated levels of seismic activity during the series of events as compared to normal baseline levels.

Amplitude measure: The strength of an earthquake can be measured in numerous ways, qualitative or quantitative, continuous or discrete. Any such indication of earthquake strength, intensity, amplitude, magnitude, energy, or damage is generically termed an amplitude measure. Some common amplitude measures are the Richter scale, the Modified Mercalli scale, and the moment magnitude scale. Amplitude measures can also include the total energy released, the seismic energy released (commonly only a small fraction of the energy released), or the amplitude of a seismic wave measured in energy, displacement, pressure, or another physical unit.

Angular coordinates: A given point on the Earth's surface can be located relative to an earthquake event by defining a pole at the earthquake's epicenter and using a two-angle polar coordinate system relative to this pole. A polar angle, denoted θ, is the angular extent of the smaller great circle arc joining the pole to the given point; polar angles can be any angles in the interval [0°, 180°], where the square brackets “[” and “]” indicate that the interval is closed at both ends. A locus of constant polar angle is similar to a line of latitude. Half-planes can be defined bounded by the polar axis and extending in different azimuthal directions. An azimuthal angle, denoted ϕ, is the angle from a reference azimuthal half-plane to a half-plane containing the given point, measured in a particular direction. Azimuthal angles can be any angles in the interval [0°, 360°), where parenthesis “)” indicates that the interval is open at one end. A locus of constant azimuthal angle is similar to a line of longitude. The angular distance along a great circle arc is also termed angular (arc) distance herein.

Antipodal: The term antipodal refers to surface locations on the opposite side of the Earth relative to a reference surface location. For example, relative to the North Pole, the entire southern hemisphere is antipodal. Any location or locations that are within the southern hemisphere or near the South Pole can be described as antipodal with respect to the North Pole. Similarly, any reference surface location on the Earth can be considered a pole with a diametrically opposite antipode, and similar antipodal locations.

Binomial model: The binomial model is a statistical model of identical independent trials, each of which can have two mutually exclusive outcomes. The distribution of probabilities of having k occurrences of one of the outcomes in n trials is termed the binomial distribution.

Body waves: Body waves are seismic waves that travel through the body of the earth. Two classes of body waves are primary or P-waves that propagate as longitudinal compressional oscillations, and secondary or S-waves that propagate as transverse shear displacements. Body waves are commonly attenuated within a few hours, such as six hours. Shear waves can only propagate through solid matter, and are not transmitted through the Earth's molten core.

Cluster: A cluster is a group of two or more earthquake events satisfying a relationship of spatial and temporal proximity.

Earthquake: An earthquake is a shaking of the Earth's surface due to a geological cause. The terms “earthquake event,” “seismic event,” or simply “event” are also used, interchangeably. As used in this disclosure, a primary earthquake event is an earthquake that could have a statistical association with a subsequent follow-on earthquake. A test earthquake event is an earthquake that could have a statistical association with either a preceding or a subsequent earthquake; that is, a test earthquake could be either a candidate primary earthquake or a candidate follow-on earthquake. In examples, more than two statistically associated earthquakes can form a cascade, in which one or more intermediate events can be both primary and follow-on events, with respect to different earthquakes of the cascade. Earthquakes that are statistically associated could have a causal relationship.

Epicenter: The epicenter of an earthquake is the point on the Earth's surface directly above the hypocenter.

Fault: A geological fault is a discontinuity in the rock of the Earth's crust at which displacement can or has occurred. Geologic forces can build up stored energy over time. Movement of the rock under the influence of geological forces can release the stored energy, some of which can be manifested in the form of an earthquake. The cycle from one earthquake or cluster of earthquakes, through a period of energy build-up till the next earthquake is termed a seismic cycle. Seismic cycles can have greatly varying duration and regularity from one fault to another.

Fit: A fit to a set of observed data is a smooth function that approximates the observed data. A fit can minimize an error measure between the observed data and the smooth function, for example a least-squares fit which minimizes the sum of squares of individual errors. Smooth functions can be linear, polynomial, or based on orthogonal or other functions, and can be continuous or segmented.

Forecast: A forecast regarding an earthquake can be an evaluation of probability, probability density, change in probability, change in probability density, enhancement of risk, or any other information that pertains to or qualifies a likelihood of occurrence of a future earthquake at or within specified spatial location(s) and/or time(s).

Foreshock: A foreshock is an earthquake that occurs before another stronger earthquake and in the same fault zone. The characteristics of aftershocks described herein are generally applicable to foreshocks also. For example, foreshocks commonly occur within minutes to days before a main quake.

Free Oscillations: Free oscillations of the Earth are standing waves that can be formed by interaction of surface waves traveling in opposite directions. Both Rayleigh waves and Love waves (see, Surface wave, below) can give rise to free oscillations in various harmonics. Free oscillations can last for many days, such as 10 days or more. Because of their longevity, free oscillations offer a candidate triggering mechanism for the associations between primary and follow-on earthquakes demonstrated herein.

Hypocenter (or focus): The hypocenter or focus of an earthquake is a point, usually below the earth's surface, from which seismic waves appear to originate.

p-value: For a given statistical model, a given null hypothesis, a given observation set, and a given statistical measure, the p-value is the probability that the statistical measure of a random observation set would be equal to or more extreme than the statistical measure of the given observation set. A small p-value is considered a basis for rejecting the null hypothesis.

Poisson model: The Poisson model is a statistical model of independent events occurring at a fixed average rate. The distribution of probabilities of having k events in a time t is termed the Poisson distribution.

Seismic: Of or related to earthquakes or other vibrations of the Earth's surface. Seismic motion, vibration, energy release, or activity can be detected or measured by seismic sensors which can be seismometers.

Surface wave: Surface waves are seismic waves that travel along the Earth's surface. Two classes of surface waves are Rayleigh waves, associated with rolling vertical ground displacement, and Love waves, associated with horizontal shear displacement. Surface waves can last for up to 24 hours, often decaying over 6-18 hours, although they can give rise to standing waves (particularly, from high magnitude events; see, free oscillations, above) that have greater longevity.

Time window: A time window is an interval of time, relative to a test earthquake event, which is of interest for evaluating associations, forecasts, or predictions of other earthquake events. The edges of the time window are termed a near time offset and a far time offset, relative to the time of occurrence of a test earthquake event. For an example test event that is a candidate primary event, a time window can extend from a near offset of 6 hours to a far offset of 3 days, after the test event. For an example test event that is a candidate follow-on event, a time window can extend from a far offset of 2.5 days to a near offset of 1 hour, before the test event. The near time offset can be zero. Near offsets can be in the range from zero to 30 days or more; far offsets can be from one hour to 1 year or more.

### II. Method for Determining Enhancement of Earthquake Risk

In embodiments of the disclosed technology, a determination is made whether a primary earthquake event leads to an enhancement of risk for follow-on earthquakes at one or more spatial regions and in one or more time windows. A person of ordinary skill in the art will understand that the spatial region and/or time window may vary. For example, an exemplary time window can extend from the time of the primary earthquake to at least one week, more typically multiple days, such as three days after the time of the primary earthquake. An exemplary spatial region can be a geometrically defined shape, such as an annulus extending from a first polar angle to a second polar angle (such as 13° to 30°) relative to a pole at the location of the primary earthquake event. Another spatial region can be antipodal, extending from a third polar angle to a fourth polar angle (such as 150° to 167°). More specifically, an answer can be determined to the following question, or to similar questions: does a primary earthquake event of Richter scale magnitude approximately 7.0 or greater cause an increased risk of follow-on earthquakes having magnitude of at least 5.0 (a damage threshold) over a given spatial region and a given time window?

A. A First Exemplary Method

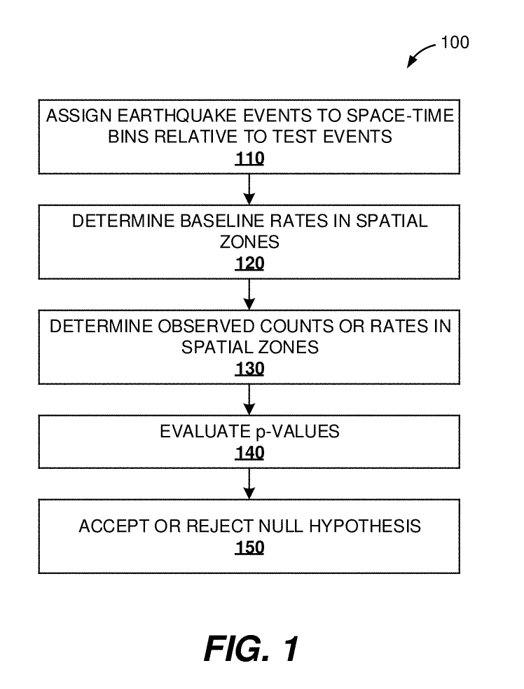

FIG. 1 is a flowchart 100 of a first exemplary method for determining enhancement of earthquake risk in a given spatial region and/or time window, according to the disclosed technology. The method uses a historical record of earthquake events around the globe. Two sets of earthquake events are used. A first set of events is a set of test events, which have predetermined properties of primary earthquake events of interest. For example, the method can be applied to primary events having a preselected Richter scale magnitude such as a Richter scale magnitude of approximately 7.0 or greater, or between 6.5 and 7.5. In another example, the set of test events can include all earthquake events above a selected magnitude, such as magnitude 6.0, or a greater magnitude. The second set of earthquake events is a corpus of earthquake events having predetermined properties of follow-on events. For example, the method can be applied to follow-on events of Richter scale magnitude approximately 6.0, or between 5.75 and 6.25. In another example, the corpus of earthquake events can include all earthquake events having magnitude greater than or equal to 5.0. Depending on the predetermined properties of primary or follow-on earthquake events, different relationships can exist between the first and second sets. The sets can be identical, disjoint, one can be a proper subset of the other, or the sets can have partial overlap with non-empty intersection. In certain disclosed embodiments, the historical record provides at least spatial location, time, and amplitude information for each event in the first and second sets.

In embodiments, the roles of test events and corpus events can be reversed: test events can be candidate follow-on events, while corpus events can include candidate primary events.

At process block 110, earthquake events are assigned to space-time bins relative to each test earthquake event. The location of a given test event can be considered a pole on the Earth's surface; other locations on the Earth's surface can be characterized by two angle coordinates, a polar angle relative to this pole and an azimuthal angle relative to an arbitrary azimuthal reference. In embodiments, the azimuthal coordinate is disregarded, and only polar angle is used as a spatial coordinate. By way of illustration, a given corpus earthquake event can have a polar angle of 53° and a time offset of minus 1073 days, relative to a first test event; the given event is binned accordingly. Relative to a second test event, the same given corpus earthquake event can have a polar angle of 122° and a time offset of plus 62 days; the given event is binned again with these relative space-time coordinates. Thus, in some embodiments, every earthquake event from the corpus of earthquake events is binned relative to every test event. In other embodiments, only certain spatial bins and/or time steps are of interest, and varying subsets of the corpus of earthquake events are binned for the different test events. Notwithstanding the varying pole positions from one test event to another, the same set of relative space-time bins can be reused for every test event.

The binned earthquake events can be used to determine both observed rates (from events binned within the given time window) and baseline rates (from events outside the given time window). By way of illustration, with a given time window of zero to three days after the test event, all events within the time window are counted towards the observed rates, while all events having relative time from minus infinity to zero or from three days to plus infinity are counted towards the baseline rate. In other embodiments, the time windows used for baseline rate determination and the given time window need not be complementary. For example, the given time window can be zero to three days after the test event, but only events having relative times from minus infinity to minus ten days or from plus ten days to plus infinity can be counted towards the baseline rate.

At process block 120, baseline event rates are determined for one or more spatial zones from binned events outside the given time window. As discussed above, a set of time bins excluding the given time window is used to gather baseline counts. Baseline counts can also be gathered over spatial zones comprising one or more spatial bins. In examples, a spatial zone can be identical with a spatial bin, which can have a width of e.g. 1° or 10° in polar angle, or a spatial zone can be a contiguous or non-contiguous aggregate of multiple spatial bins, for example a zone spanning 150°-167° in polar angle. The total number of baseline counts can be an integer. The baseline count can be divided by a total time extent of the baseline time bins to obtain a baseline rate. The baseline count can also be divided by a spatial extent, in e.g. degrees of polar angle, or million square miles, or by the width of an amplitude measure of either the test event set or the corpus of earthquake events to obtain baseline rates in units of e.g. events/year/million square miles, or events/day/Richter magnitude-squared, or similar normalized units. Baseline rates need not be integers.

At process block 130, observed event counts or rates are determined for one or more spatial zones from binned events in the given time window. The given time window can be a single time bin or an aggregate of multiple contiguous or non-contiguous time bins. The given time window is used to gather observed event counts. Similar to baseline counts, observed event counts can be gathered over spatial zones comprising one or more spatial bins. The observed event count can be divided by the given time window to obtain an observed event rate. In some examples, the unit of time can be equal to the width of the time window, so that the observed event rate can be numerically equal to the observed event count, however this is not a requirement. Similar to the baseline count, the observed event count can also be divided by an extent of a spatial zone, or by a range of amplitude measures, to obtain normalized observed event rates in various units. In embodiments, the normalization applied to the baseline event rates is the same as the normalization applied to the observed event rates.

At process block 140, one or more p-values are evaluated based on the observed event rates, the baseline event rates, and a statistical model of earthquake events according to a null hypothesis. An exemplary statistical model can be that earthquake events are uncorrelated, in which case the observed event rates should be equal to the baseline event rates, to within statistical fluctuations. This model is a null hypothesis. The statistical model can assume Poisson statistics for the earthquake events. For any spatial zone, the Poisson model can have a rate coefficient equal to the determined baseline rate for that zone. In embodiments, the Poisson model can be approximated by and/or evaluated using a binomial model. Using the baseline rate and the statistical model, the probability of getting at least the observed event rate in a given spatial zone can be determined, and this probability is the p-value for the given spatial zone. In embodiments, the p-value is calculated independently for each spatial zone. In embodiments, a single p-value can be calculated for the ensemble of observed event rates over all spatial zones.

A high p-value suggests that an observed event rate could have occurred by chance with reasonable likelihood, in accordance with the statistical model. In such a case the null hypothesis cannot be rejected. A low p-value suggests that the observed event rate is unlikely to have occurred by chance based on the statistical model. The lower the p-value, the less likelihood that the statistical model can explain the observed event rate. For sufficiently low p-values, the null hypothesis can be rejected. A predetermined threshold p-value number, below which the null hypothesis is rejected, is called the significance level. A person of ordinary skill in the art will understand that significance levels can be selected as desired between 0.000001 and 0.3, commonly 0.0001, 0.0002, 0.0005, 0.001, 0.002, 0.005, 0.01, 0.02, 0.05, or 0.1; for certain disclosed embodiments, significance levels of 0.05 or 0.005 can be used.

At process block 150, the null hypothesis is accepted or rejected based at least partly on the evaluated p-values.

B. An Illustration of the Disclosed Method

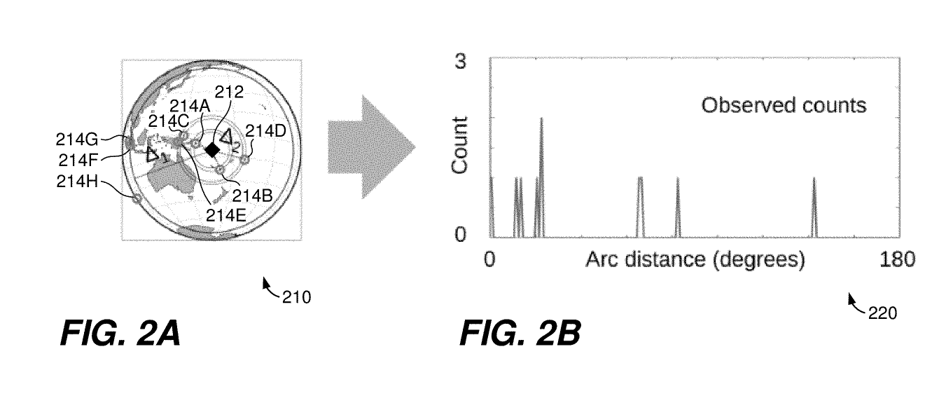

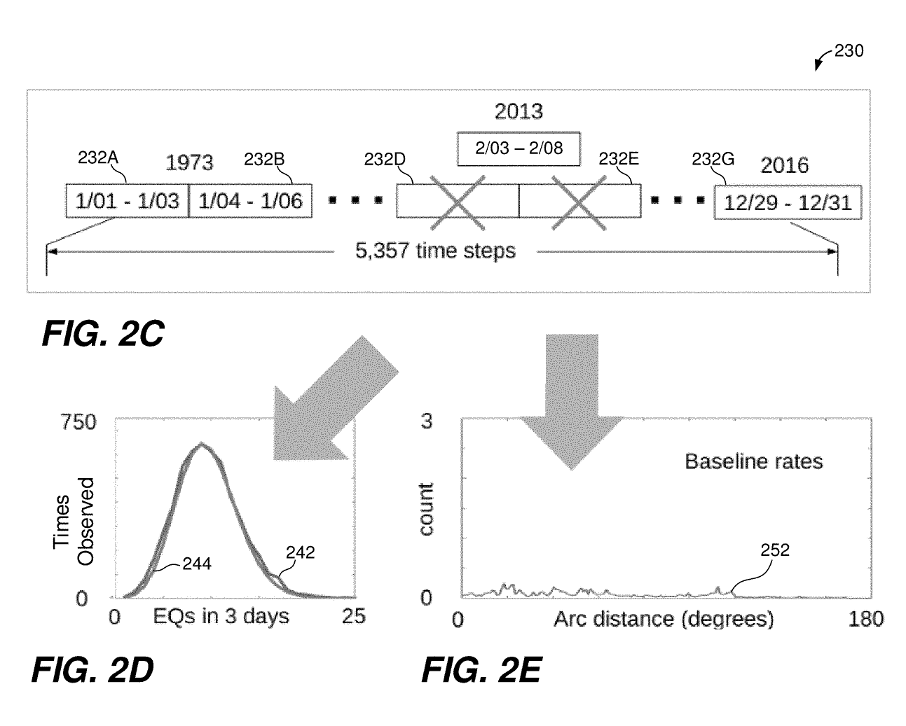

FIGS. 2A-2E are a series of diagrams illustrating an application of the disclosed technology. FIG. 2A is a diagram 210 showing a number of earthquake events on a map of the Earth. Marker 212, shown as a solid diamond, represents a primary test event that occurred in the Solomon Islands on Feb. 6, 2013. Markers 214A-H, shown as open circles, represent earthquake events from a corpus of events that occurred within a given time window following the primary earthquake 212. In this illustration, the given time window has a width of three days. FIG. 2B depicts a histogram 220 showing the observed counts binned according to their angular (arc) distance in degrees, measured from the location of primary earthquake 212. The bins are 1° wide. For simplicity of illustration, only events within the given time window are shown; thus the time binning is inherent in FIG. 2B. That is, each space-time bin illustrated is 1°×3 days wide. In this example, the primary test event 212 is also a member of the corpus of earthquake events; it is shown at an angular (arc) distance of 0° in FIG. 2B.

FIG. 2C is a diagram illustrating time bins used for estimating the baseline rate of earthquake events. The historical data begins at Jan. 1, 1973 and ends at Dec. 31, 2016, a total of 44 years, which can be segmented into 5,357 three-day bins. Bin 232A covers Jan. 1-3, 1973, bin 232B covers Jan. 4-6, 1973, and so on until bin 232G covering Dec. 29-31, 2016. The primary event 212 occurred at 01:12 UTC on Feb. 6, 2013, so the given time window extends until 01:12 UTC on Feb. 9, 2013. For simplicity of illustration, this is shown as a time bin 232E covering February 6, 7, and 8. Events in this bin are counted toward observed events and are not counted toward baseline events. Similarly, events in the preceding time bin 232D, covering February 3, 4, and 5, could be correlated with the primary event 212 and are also excluded from the baseline counts. The two excluded bins 232D, 232E are indicated by overlaid “X” symbols. Events in the remaining 5,355 bins are included in the baseline counts for respective spatial zones.

FIG. 2D shows a histogram 242 of baseline counts integrated over all spatial zones for the 5,355 baseline time bins of FIG. 2C. Overlaid is a smooth curve 244 which represents a Poisson distribution fitted to the histogram 242. The evident goodness of fit between the baseline count histogram 242 and the fitted curve 244 confirms the assumption that baseline events are independent and uncorrelated.

FIG. 2E is a graph 252 of baseline rates (earthquake events per 3-day time bin) for each of 1° spatial bin, for the primary test event 212. Because the locations of two test events are in general different, the events counted towards a particular spatial bin will also be different for the two test events. In other words, baseline rates can be calculated specific to a particular test event.

In some embodiments, baseline rates can be averaged over all test events, and can be fitted to a smooth curve.

C. Exemplary Statistical Analysis

Earthquake data were obtained from the United States Geological Survey's Earthquake Hazards Program archives (at http://earthquake.usgs.gov) for all earthquakes with magnitudes ≥5.0M. The time period covered begins at the start of 1973 and extends through the end of 2016. These data were used for constructing test-sets and defining the baseline rates of seismicity in two numerical experiments. Earthquake events were analyzed in two experiments, as described below.

### 1. Forward-looking Experiment 1

A first forward-looking experiment (Experiment 1) was designed and implemented to test whether large events are associated with the occurrence of subsequent earthquakes. Five sets of test events were extracted having Richter scale magnitudes in ranges [6.0M, 6.1M), [6.5M, 6.6M), [7.0M, 7.1M), [7.5M, 7.6M) and [8.0M, ∞) respectively, with corresponding labels “6.0M,” “6.5M,” “7.0M,” “7.5M,” and “8.0M.” A corpus of events having Richter scale magnitudes ≥5.0M was also prepared. The threshold of 5.0M assures that all events in the corpus were globally detectable, thus avoiding biases due to positioning of seismic detectors. In the test event sets and in the corpus of events, each event has an associated time of occurrence and an epicenter with latitude and longitude.

For certain embodiments, a time window of zero to three days after the test event was chosen to test for associated events. A person of ordinary skill in the art will appreciate that other time windows can be selected, such as up to at least seven days after the test event. For each test event (such as 212), the corpus of events was searched to find observed events within the time window (such as 214A-H). The latitude and longitude of the test event represents a pole, and the angular (arc) distance is computed from the pole to each observed event (such as indicated by dotted lines “Δ₁” and “Δ₂” in FIG. 2A). The observed events were then spatially binned at one degree intervals (such as shown in FIG. 2B).

Each test event also has an associated control group of events from which baseline counts and rates were determined. For the selected three day time window, the 44 year archive history yields 5,355 time bins that are spaced from the test event, as explained above in the context of FIG. 2C. Corpus events in these 5,355 time bins form the control group of events, and were spatially binned relative to the pole of a current test event to obtain a histogram of baseline counts across the spatial bins, in the frame of reference of the current test event. Dividing baseline counts by 5,355, baseline rates were determined for each test event, in units of events per three-day time bin, per degree of polar angle (such as shown in FIG. 2E).

Because the unit of time is the same as the length of the time window, the observed event rates (in units of events per three-day time bin, per degree of polar angle) are numerically equal to the observed event counts, and no division is necessary.

Then, p-values were calculated using the binomial distribution, for which a probability mass function can be expressed as

f(k; n, p)=[n!/((n-k)!*k!)]*p^{k}*(1-p)^{(n-k)}

where f (k; n, p) is the probability of getting exactly k successes in n trials, where p is the probability of a success in each trial. The term in square brackets is the binomial coefficient, sometimes read “n choose k.”

The cumulative distribution function is

$$F ( k ; n , p ) = {\sum }_{i = 0}^{k} f ( i ; n , p )$$

and the probability of getting at least k successes in n trials is simply 1-F (k-1; n, p).

For each spatial bin, the binomial distribution was applied by using the sum of baseline counts and observed counts as n, using p=1/(5,355+1)=1/5,356 as the probability of any one event falling within the given time window (one three-day interval), and using the observed counts as k. The value of p follows from the time invariance of the statistical model, and is the same for all spatial bins. This can also be viewed as the odds determination of the relative risk effectively canceling out the baseline variability.

Then, the p-value (which is distinct from the above probability p) for this spatial bin is the probability of getting at least k successes in n trials, or p-value=1-F (k-1; n, p).

In the R programming language, the cumulative distribution function can be calculated using the pbinom (k, n, p) call. In embodiments, the k argument to the function call can be observed counts minus one, or observed counts minus half, since pbinom ( ) can accept non-integer arguments. This addresses a subtlety due to the null distribution being a random expression of a uniform distribution (all values from 0 to 1 being equally possible). Using (counts—0) results in an optimistic p-value, while using (counts—1) yields a pessimistic estimate. Given the uniform distribution, there is no ‘correct’ value. In an embodiment, the p-value was calculated as a “mid”-p-value using (counts—0.5). Thus,

p-value=1—pbinom (counts—0.5, n, p).

A spectral analysis of the p-values demonstrates high levels of periodicity and provides strong evidence against the null hypothesis, which asserts undeviating probabilities in space and time.

### 2. Filtering Foreshocks and Aftershocks

Care was taken to remove known clustering processes from the analysis, which could anomalously elevate observed counts and overshadow the question of present interest. Foreshocks and aftershocks were both removed from the archival data, so as to be absent both from test event sets and from the corpus of earthquake events. Aftershocks tend to spatially occur in areas that have positive stress changes following large earthquakes and are associated with local fracture zones. Statistically, there is a connection between the fractal dimension of the aftershock spatial distribution and the pre-existing fault system. The number of aftershocks follow distribution patterns based on the magnitude of the main event, and are sometimes described by an epidemic type of model, in which events trigger other events in a cascade.

In one embodiment, an empirical approach was used to identify and remove aftershocks. For each test event, observed event rates were determined within the 3-day time window and within a preselected polar angle, such as a polar angle of 5.5° relative to the epicenter of a current test event. These observed event rates were compared with the corresponding baseline rates; if the ratio observed/baseline was greater than or equal to a preselected threshold, such as a threshold ratio of 20, then the observed events were regarded as aftershocks and were omitted from all test event sets and from the corpus of earthquake events. Two special cases were used for stronger earthquakes: polar angles within [0°, 7.5°] were considered for an 8.8M event, and polar angles within [0°, 11.5°] were considered for a 9.1M event.

Similar methods were used to remove foreshocks, by examining observed events in a three-day window preceding a current test event.

Variations of this empirical method or other aftershock filtering algorithms can be used in other embodiments. For example, the spatial extent (e.g. polar angle ≤5.5°), the temporal extent (e.g. three days), or the activity threshold (e.g. observed/baseline ≥20) can all be varied. In other embodiments, events within the temporal extent and within the spatial extent can be disregarded as being possible aftershocks. Temporal extents from up to 1 day to up to 10 days can be used. Spatial extents from up to 5° to up to 25° or up to 30° relative to a test event can be used. Alternatively or additionally, the regions of aftershocks around each test event can be determined from specific knowledge of nearby faults and seismic activity; such a spatial zone can extend from a few km to tens of km to more than 100 km in various examples, and can have a regular or irregular shape. The time window and/or an aftershock region can be extended based on subsequent aftershocks, to account for aftershocks of the aftershocks, and so forth. An extension of time window or aftershock region can be dependent on the magnitude (or, other amplitude measure) of one or more observed aftershocks. As another variation, in a set of clustered events, an event having greatest magnitude (or, other amplitude measure) can be retained, while the remaining clustered events can be discarded. In further examples, a set of clustered events can be replaced by a single event having a magnitude corresponding to the total energy release of all clustered events, and a location corresponding to the centroid of the total energy released in the clustered events. The replacement event can have a finite spatial and temporal extent resulting in broadening of spatial and temporal bins used in downstream analysis.

### 3. Additional Filtering of Clustered Events

Occasionally, clustered events can be present even after filtering for foreshocks or aftershocks, for example when there are only two events and the observed/baseline threshold is not exceeded. In an embodiment, pairs of observed events (i.e. within the three-day time window) were checked for physical proximity, particularly by checking whether their epicenter spacing was less than the spatial bin width of 1° angular (arc) distance, approximately 111 km. Among such proximate events, the earlier (or, earliest) occurring event was kept and the other(s) dropped from the observed counts. Thus, earthquakes caused by local stress redistribution processes (i.e., non-independent, non-Poisson processes) were prevented from influencing the statistical analysis. As a variation, similar cluster filtering can also be applied to baseline counts.

### 4. Backward-looking Experiment 2

A second backward-looking experiment (Experiment 2) was designed and implemented, to test whether earthquakes are associated with large precursors. Experiment 2 was complementary to Experiment 1. Five sets of test events were extracted having Richter scale magnitudes in ranges [5.0M, 5.1M), [5.5M, 5.6M), [6.0M, 6.1M), and [6.5M, ∞) respectively, with corresponding labels “5.0M,” “5.5M,” “6.0M,” and “6.5M.” The threshold of 5.0M assures that all events in the corpus were globally detectable, thus avoiding biases due to positioning of seismic detectors. A corpus of events having Richter scale magnitudes ≥6.5M was prepared for this experiment. In the test event sets and in the corpus of events, each event has an associated time of occurrence and an epicenter with latitude and longitude.

In this experiment, a time window of zero to three days prior to the test event was chosen to test for associated triggering events. Identification and binning of observed events was performed similarly to Experiment 1. As for Experiment 1, 5,355 time bins were used to identify control group events for determining baseline counts and rates. Both the preceding three day window and the three day bin following a current test event were excluded from the baseline counting. Baseline events were binned and baseline rates were determined in a manner similar to Experiment 1. Observed events were binned and observed event rates were determined in a manner similar to Experiment 1. Statistical analysis with determination of p-values was also performed in a manner similar to Experiment 1.

### 5. Exemplary Results

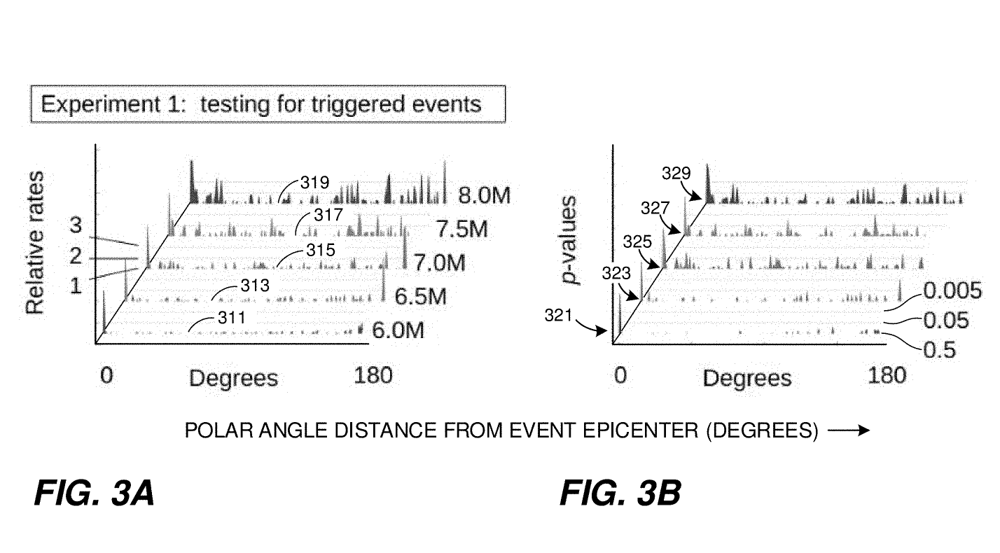

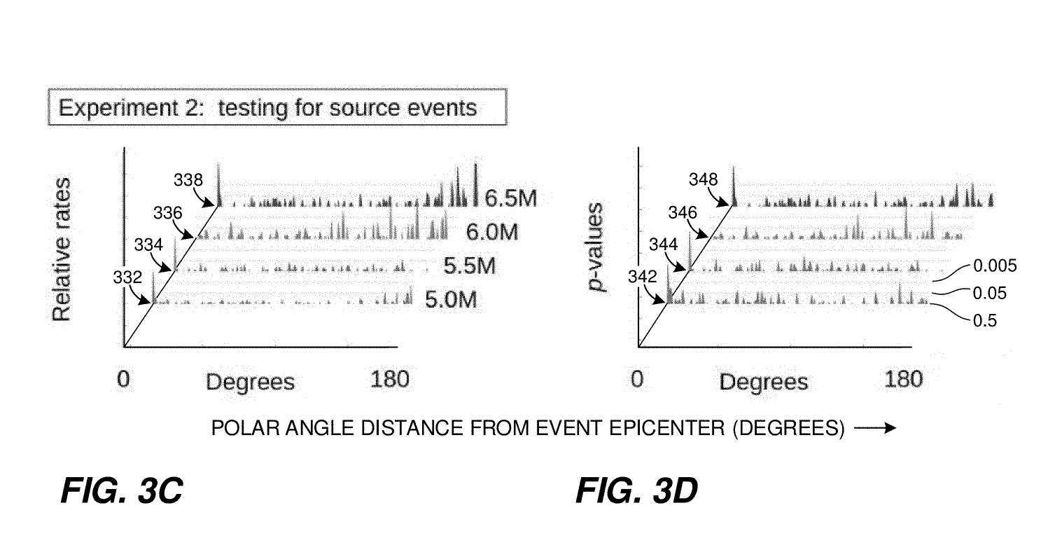

FIGS. 3A-3D are a first set of graphs of relative rates and p-values, for triggered events of magnitude 6-8 at varying distances from an epicenter (in degrees), showing results of analysis of earthquake events according to the disclosed technology. As noted, FIGS. 3A-3B pertain to forward-looking Experiment 1 described above, while FIGS. 3C-3D are similar graphs for backward-looking Experiment 2 described above.

FIG. 3A presents relative rate (observed/baseline) versus angular (arc) distance for each of five sets of test events. Graphs 311, 313, 315, 317, 319 correspond respectively to the test event sets labeled “6.0M,” “6.5M,” “7.0M,” “7.5M,” and “8.0M.” Three horizontal dotted grid lines are shown for each graph and correspond to relative rates equal to 1, 2, and 3 respectively. That is, FIG. 3A shows how many times the observed event rates are above the corresponding baseline rates. To avoid clutter on the graph, bins with relative rates below 1 are suppressed.

FIG. 3B presents a similar view of the five sets of test events, however the vertical axis of FIG. 3B shows p-value instead of relative rate. Graphs 321, 323, 325, 327, 329 correspond respectively to the test event sets labeled “6.0M,” “6.5M,” “7.0M,” “7.5M,” and “8.0M.” The p-value is evaluated for each test event set and each spatial bin according to statistical methods described herein. Three horizontal dotted grid lines are shown for each graph and correspond to p-values equal to 0.5, 0.05, and 0.005 respectively; the vertical axis is a negative logarithmic scale. The peaks observed at 0° in FIGS. 3A-3B are an effect of the test events being included within the corpus of events being analyzed.

Comparing the several primary test event sets, FIGS. 3A-3B, establish that larger source events can yield relative rates 2-3× the baseline rates. As seen in FIG. 3B, many p-values are between 0.05 and 0.005, which argues against the null hypothesis and demonstrate a statistical association between primary and follow-on events.

Turning to Experiment 2, FIG. 3C presents relative rate (observed/baseline) versus angular (arc) distance for each of four sets of test events. Graphs 332, 334, 336, 338 correspond respectively to the test event sets labeled “5.0M,” “5.5M,” “6.0M,” and “6.5M.” Three horizontal dotted grid lines are shown for each graph and correspond to relative rates equal to 1, 2, and 3 respectively. To avoid clutter on the graph, bins with relative rates below 1 are suppressed.

FIG. 3D presents a similar view of the four sets of test events, however p-value is shown on the vertical axis of FIG. 3B, instead of relative rate. Graphs 342, 344, 346, 348 correspond respectively to the test event sets labeled “5.0M,” “5.5M,” “6.0M,” and “6.5M.” The p-value is evaluated for each test event set and each spatial bin according to statistical methods described herein. Three horizontal dotted grid lines are shown for each graph and correspond to p-values equal to 0.5, 0.05, and 0.005 respectively; the vertical axis is a negative logarithmic scale. The peaks observed at 0° in FIGS. 3C-3D are events associated with the test events that were not filtered by the aftershock test.

FIGS. 3C-3D show that sources occur at relative rates of 2-3× the baseline rates, and have low p-values, confirming the statistical association demonstrated by FIGS. 3A-3B.

In further examples, relative rates can be normalized based on sample size.

D. A Second Exemplary Method

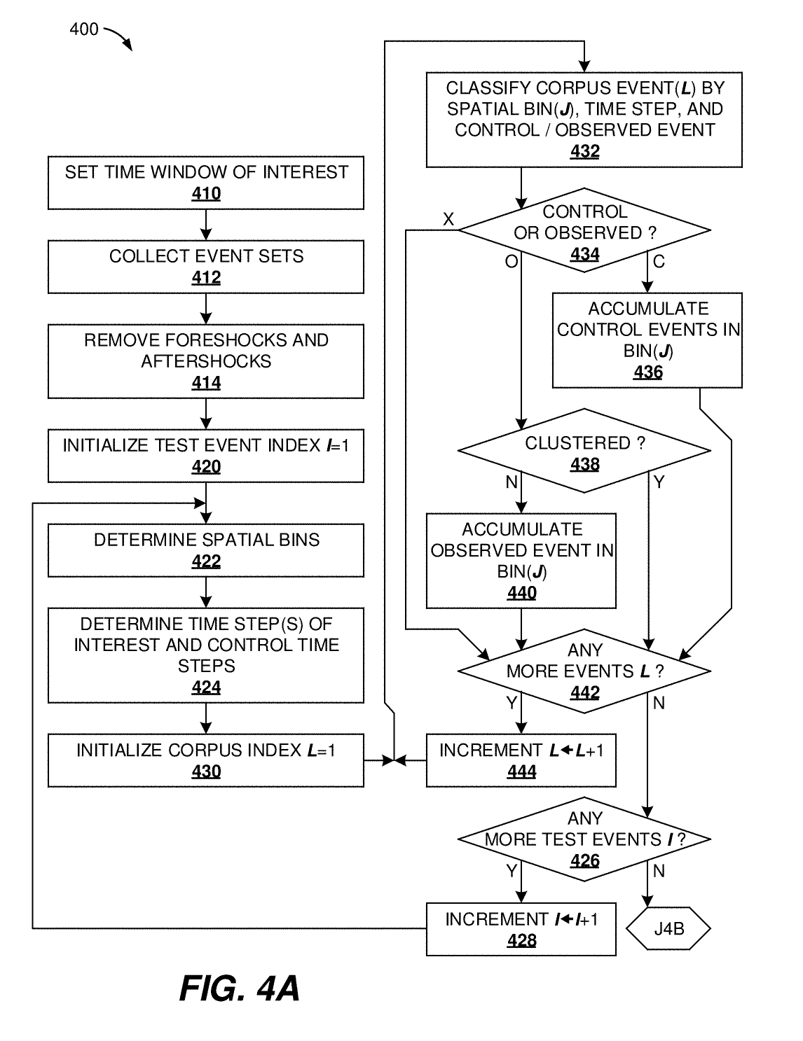

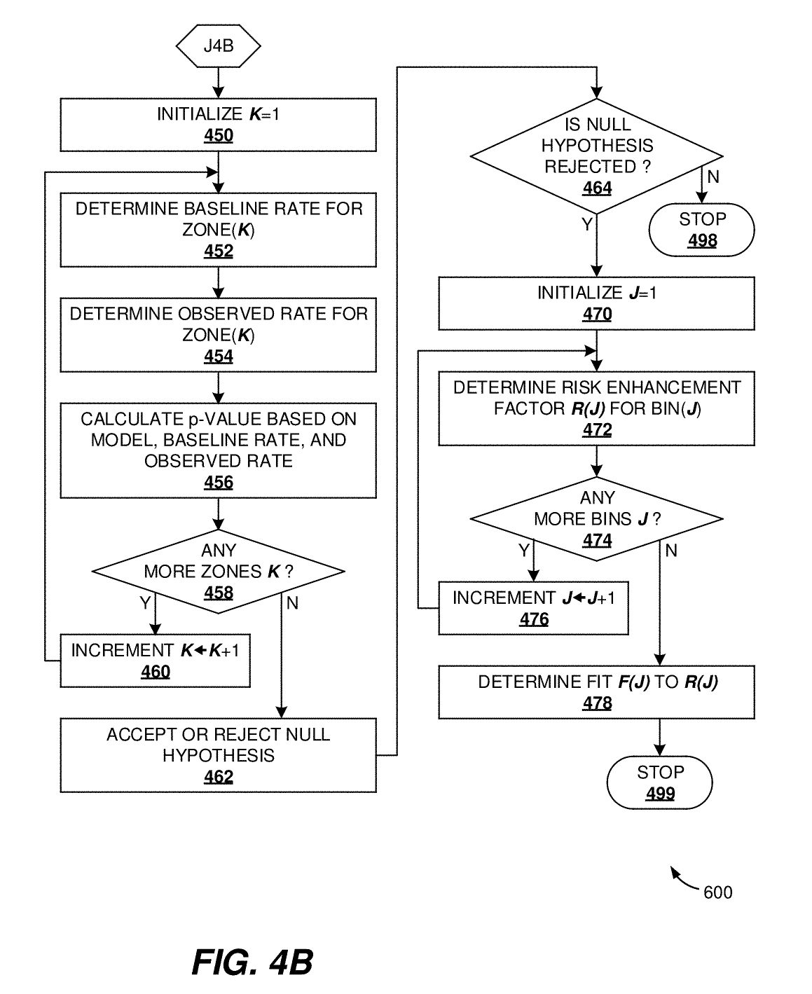

FIGS. 4A-4B depict a flowchart 400 of a second exemplary method for determining enhanced earthquake risk according to the disclosed technology. The method proceeds in four phases; in certain disclosed embodiments, only a subset of the phases are performed, or one or more phases are performed with variations, or one or more phases are repeated with additional sets of events. In a first phase, the analysis is set up with relevant sets of events and other parameters. In a second phase, a corpus of earthquake events is binned to collect baseline and observed event counts. In a third phase, p-values are calculated based on baseline and observed rates, and a statistical model, to make a determination regarding a null hypothesis. In a fourth phase, risk enhancement factors are calculated for spatial bins, and a fitted function is determined.

Starting with the first phase, a time window is set at process block 410. The objective of the method is to study whether events within the time window are associated with test events, and optionally to determine the enhancement of risk within the set time window. For example, the time window can be an interval zero to three days after a test event (forward-looking study) or three days to zero prior to the test event (backward-looking study). In a forward-looking study, each test event is a candidate primary event, while in a backward-looking study, each test event is a candidate follow-on event.

At process block 412, sets of events are collected from e.g. a historical archive, and at process block 414 foreshocks and aftershocks are removed as described herein. Through these two process blocks, at least two sets of earthquake events are prepared: a set of test earthquake events; and another corpus of earthquake events.

At process block 420, an outer loop over test events is begun, using index I, which is initialized to 1. At process block 422, the spatial bins for the current test event (with index I) are set up. In examples, the spatial bins are determined according to a polar angle measured from a pole at the epicenter of the test event, and process block 422 comprises setting the latitude and longitude of the current test event's epicenter as a pole of a polar coordinate system. At process block 424, one or more time steps of the historical archive duration are marked as corresponding to the test window, relative to the time of occurrence of the current test event. Other time steps are considered control time steps. In an example, one of 5,357 available time steps is the chosen time window of interest, 5,355 of the available time steps are control time steps, and a remaining one of the available time steps is ignored for reason of possibly being associated with the test event, but not being within the time window of interest. In other examples, the time window of interest can correspond to multiple time steps, there can be no ignored time steps, or there can be multiple ignored time steps before and/or after the time of occurrence of the test event.

Proceeding to the second phase, at process block 430, an inner loop over corpus events is begun, using index L, which is initialized to 1. At process block 432, the current corpus event (having index L) is classified into a space bin denoted by index J and a time step, which together define a space-time bin. The corpus event is also classified, according to its time step, as being a control event, an observed event, or an ignored event. At process block 434, the method branches according to the classification of the current corpus event. If the event is a control event, the C branch is followed to process block 436, where the event is accumulated in spatial bin J of the control events, to be counted as a baseline event, and the method continues to process block 442. If the event is an ignored event, the X branch is followed directly to process block 442. However, if the event is an observed event, the O branch is followed to process block 438, where a check is made whether the current corpus event is clustered with a preceding event in the observed events for the current test event. In embodiments where the earliest occurring cluster event is retained and later occurring cluster events are discarded, the operation at process block 438 can be facilitated by processing corpus events in order of increasing time of occurrence. In other embodiments, the cluster filtering can be performed after the loop over corpus events is complete.

If the current corpus event is determined not to be clustered with another observed event, then the N branch is followed from process block 438 to process block 440 where the corpus event is accumulated into bin J of the observed events, before continuing to process block 442. However, if the current corpus event is a later occurring member of a cluster of observed events, then the Y branch is followed directly from process block 438 to process block 442, thereby omitting the current corpus event from subsequent analysis.

Thus, the method eventually reaches process block 442 regardless of the classification of the current corpus event. At process block 442, a check is made whether there are any more corpus events. If there are more events, then, following the Y branch, the corpus event index L is incremented at process block 444 before returning to process block 432 for another iteration of the inner loop over corpus events. If there are no more corpus events, then the N branch is followed to process block 426, to check status of the outer loop over test events. If there are additional test events, then the test event index I is incremented at process block 428 before returning to process block 422 for another iteration of the outer loop over test events. If there are no more test events, then the outer loop and the second phase are both complete, and the method proceeds via the N branch to jump tag J4B and thence to matching jump tag J4B in FIG. 4B.

From jump tag J4B, the method proceeds to process block 450 to begin the third phase. A loop over spatial zones is begun, using index K for spatial zones, with the index K being initialized to 1 at process block 450. In some embodiments, spatial zones are identical to spatial bins, and can be 1° wide in angular (arc) distance. In other embodiments spatial zones can be formed from groups of spatial bins.

At process blocks 452 and 454, the baseline and observed count rates are determined for zone K from the baseline and observed counts in the corresponding bins J as accumulated in the second phase. At process block 456, a p-value is calculated for the current zone as described herein, using the baseline and observed event rates, and a statistical model. At process block 458, a check is made whether there are additional zones to be considered. If yes, then the Y branch is followed to process block 460, where index K is incremented before returning to process block 452 for another loop iteration on the next zone. If there are no more zones, then the method follows the N branch to process block 462, where p-value results are analyzed to determine whether to accept or reject a null hypothesis. In embodiments, the null hypothesis is that there is no association between test events and corpus events, meaning that corpus events are independent of test events. In embodiments, the null hypothesis can be accepted or rejected individually or independently for each spatial zone, while in other embodiments the null hypothesis is accepted or rejected en masse, based, for example, on a comparison of the distribution of p-values for the spatial zones.

At process block 464, a check is made whether the null hypothesis has been accepted or rejected. If the null hypothesis is accepted, then the method follows the N branch and terminates at stop block 498. If the null hypothesis is rejected for one spatial zone, a group of spatial zones, or all spatial zones, then the method follows the Y branch to process block 470 to begin the optional fourth phase.

At process block 470, a loop over spatial bins J is begun, with J being initialized to 1. At process block 472, a risk enhancement factor R(J) is determined for the current bin. In embodiments, the risk enhancement factor can be simply the relative rate, observed/baseline. At process block 474, the loop status is checked. If there are more spatial bins, the Y branch is followed to process block 476, where index J is incremented before returning to process block 472 for another loop iteration for the next spatial bin. If there are no more spatial bins, the N branch is followed to process block 478, where a fit is performed on the determined R(J) values. In embodiments, the fit can be one or more of: a least-squares fit, a polynomial fit, a fit to a series of Legendre polynomials, a weighted fit, a spline fit, a continuous or discontinuous piecewise fit, or another class of fit.

This completes the fourth phase of the method, which terminates at stop block 499.

E. Exemplary Results

### 1. Risk Enhancement

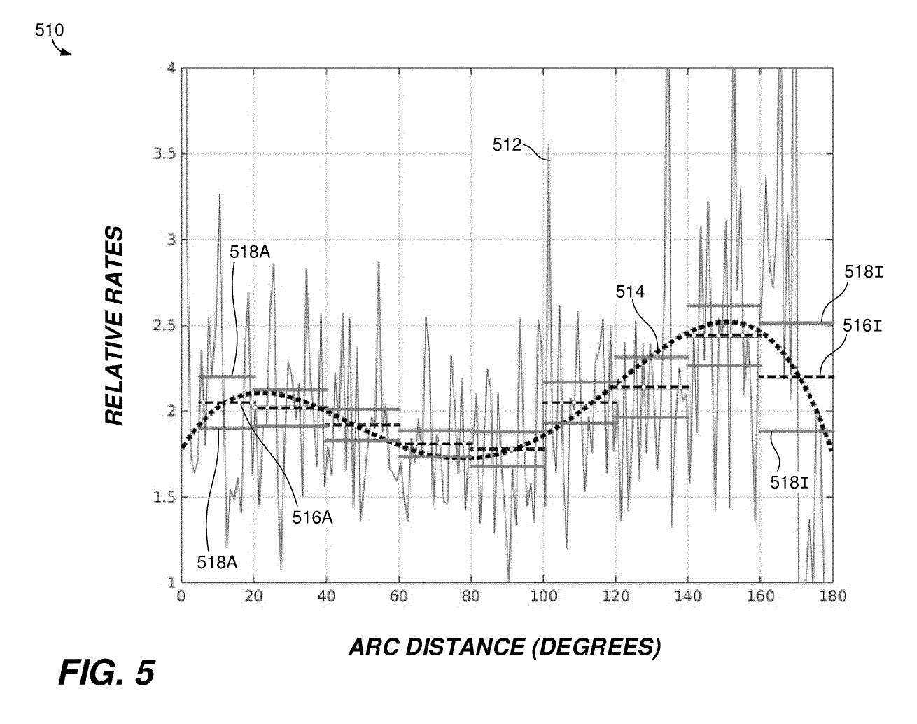

FIG. 5 is a graph of relative rates and fitted risk enhancement at varying distances from an epicenter (in degrees), showing results of analysis of earthquake events according to the disclosed technology.

FIG. 5 shows a graph 510 including a composite trace 512 of relative rates (observed/baseline) for multiple runs of Experiment 2. In particular, ten test event sets were analyzed for test events of magnitude [5.0M, 5.1M), [5.5M, 5.6M), [5.6M, 5.7M), [5.7M, 5.8M), [5.8M, 5.9M), [5.9M, 6.0M), [6.0M, 6.1M), [6.1M, 6.2M), [6.2M, 6.5M), and [6.5M, ∞) and having 10,017, 3,366, 2,633, 2,030, 1,551, 1,293, 1,013, 812, 1,497, and 1,714 test events respectively. A global pattern is discernible.

Also shown in FIG. 5 is curve 514, which is a fourth order polynomial fit g(θ) to the data of composite trace 512. In this illustration,

g(θ)=1.7780+(3.4426·10⁻²·θ)−(1.1122·10⁻³·θ²)+(1.1068·10⁻⁵·θ³)−(3.3090·10⁻⁸·θ⁴)

Curve 514 (dotted line) shows the surprising and unexpected enhancement of earthquake risk having peaks at approximate polar angles of 20° and 160°. Relative to the location of a primary event, these zones are the most likely locations for increased seismicity in their respective hemispheres. It is particularly surprising that the antipodal risk in the vicinity of 160° is substantially stronger than in the near hemisphere. Means (dashed lines 516A-516I) and error bars (solid lines 518A-518I) are shown for nine spatial zones covering polar angles (angular arc distance) θ from 5° to 180°.

The zones of enhanced risk seen in FIG. 5 provide a backdrop against which patterns of earthquakes occurring within a few days of each other can be studied.

### 2. Cascaded Earthquake Events

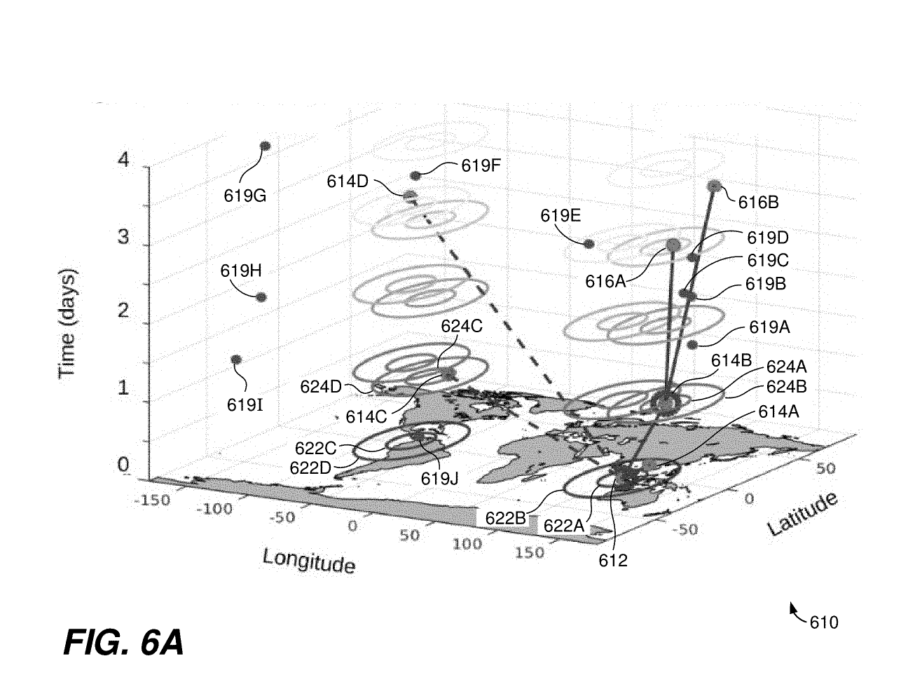

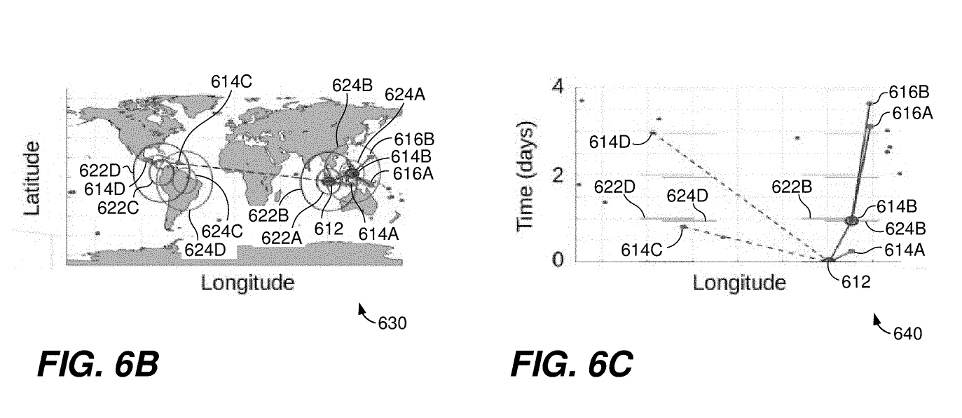

FIGS. 6A-6C are a set of diagrams illustrating spatial and temporal relationships of a cascade of earthquake events determined according to the disclosed technology. The same set of events is depicted in all three diagrams; some features are easier to see in some views than in others.

FIG. 6A is a 3-D view 610 showing space and time locations of a number of earthquake events following an initial event 612 at Sumatra, Indonesia. The events considered likely to have been stimulated by event 612 include events 614A, 614B in the nearby areas of eastern Indonesia and the Philippines, and events 614C, 614D in the western hemisphere, all of which are within zones of enhanced risk relative to event 612. Rings 622A, 622B mark the proximate zone of increased earthquake risk between 13°-30° polar angle relative to event 612. The rings are labeled at the time of event 612, and replicated at 1, 2, and 3 days after the event in FIG. 6A. Similarly, rings 622C, 622D mark the antipodal zone of increased earthquake risk between 150°-167° polar angle from the epicenter of event 612.

Further, events 616A, 616B are within the enhanced risk zones of event 614B and are considered likely to have been stimulated by event 614B. Rings 624A, 624B mark the proximate zone of increased earthquake risk between 13°-30° polar angle relative to event 614B. The rings are labeled at the time of event 614B, and replicated at 1, 2, and 3 days after the event. Similarly, rings 624C, 624D mark the antipodal zone of increased earthquake risk between 150°-167° polar angle from the epicenter of event 614B.

Solid lines are used to depict presumed linkages in a proximate zone (e.g. joining events 612→614A→616A), and dashed lines are used to depict presumed linkages in an antipodal zone (e.g. joining events 612→614C).

Also shown are ten additional earthquake events 619A-619J that are not specifically within the zones of greatest earthquake risk enhancement, but could have been stimulated by one or another preceding earthquake.

FIG. 6B is a diagram 630 showing in 2-D view the spatial relationships between events 612, 614A-614D, and 616A-616B, without any time information. The proximate and antipodal risk enhancement zones 622A-622D and 624A-624D are also shown.

FIG. 6C is a diagram 640 showing in 2-D view the longitude position and time relationships between events 612, 614A-614D, and 616A-616B, without any latitude information. (For this cascade of events, the longitude is the dominant distinguishing spatial coordinate between events.) The proximate and antipodal risk enhancement zones 622B, 622D and 624B, 624D are also shown as straight line projections of the corresponding rings of FIGS. 6A-6B. To avoid clutter, the additional earthquake events 619A-619J are not labeled in FIGS. 6B-6C.

Thus the prospect of multiply cascaded earthquake events is very real, and the risk enhancement due to a primary earthquake merits the generation and dissemination of alerts to affected zones.

### III. Method for Generating and Disseminating an Earthquake Alert

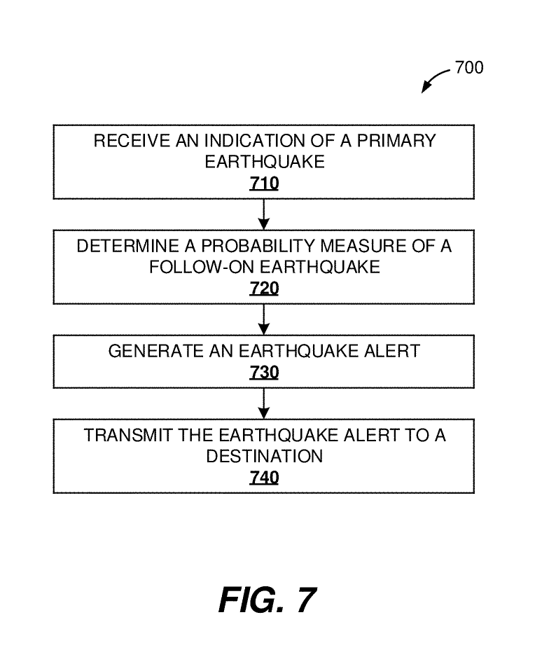

FIG. 7 is a flowchart 700 of an exemplary method for generating and disseminating an earthquake alert according to the disclosed technology. The results of analysis similar to that described herein are used to forecast zones of increased earthquake risk following a new primary earthquake event. An earthquake alert is generated and transmitted to one or more appropriate destinations.

At process block 710, an indication of a primary earthquake is received. In embodiments, the indication can be received from a seismometer, or from a seismometer network which can be a local, regional, or international seismometer network. The seismometer can be a specialized scientific instrument, or can be a general-purpose accelerometer such as in a smartphone. Smartphone accelerometers can form a crowd-sourced seismometer network. In embodiments, the indication can be received from a news service or a messaging service. The indication can be received over or through a dedicated communication network, a public communication network, a computing cloud, or the Internet. In embodiments, the indication can include the location of an epicenter or hypocenter of the primary earthquake, a time of the earthquake's occurrence, and/or an amplitude measure of the primary earthquake.

At process block 720, a probability measure is determined for a follow-on earthquake at a second spatial area and over a second time window. In embodiments, the second spatial area can be all or part of an annular zone on the Earth's surface that is symmetrically positioned about the primary earthquake's epicenter. The second spatial area can be outside an aftershock zone around the primary earthquake's epicenter, and/or the second time window can be outside an aftershock window following the primary earthquake's time of occurrence.

In embodiments, the second spatial area can be characterized as, or can include, one or more of the following, in any combination: an area on the Earth's surface (e.g. the Mediterranean Sea, or the area bounded by lines of latitude 11° N, 12° N and lines of longitude 151° W, 152° W); a spherical polygon, an area defined by a polar angle extent relative to a pole at the first location; an area defined by a polar angle extent and an azimuthal extent relative to a pole at the first location; an area defined by a polar angle extent relative to a pole of the Earth; an area defined by a polar angle extent and an azimuthal extent relative to a pole of the Earth; an area including at least one point having a first polar angle, such as 20°, relative to a pole at the first location; an area including all points on the Earth's surface having a first polar angle, such as 20°, relative to a pole at the first location; an area including at least one point having a first polar angle relative to a pole at the first location, wherein the first polar angle is between 13° and 31° (inclusive); an area including at least one point having a second polar angle, such as 160°, relative to a pole at the first location; an area including all points on the Earth's surface having a second polar angle, such as 160°, relative to a pole at the first location; an area including at least one point having a second polar angle relative to a pole at the first location, wherein the first polar angle is between 150° and 168° (inclusive); an administrative area (e.g. the state of Oregon); or a population center (e.g. metropolitan Los Angeles).

In embodiments, the second time window can include one or more of: a period beginning at the first time; a period beginning at about 6 hours after the first time; a period beginning at about 24 hours after the first time; a period beginning at 0-1, 1-2, 2-3, 3-5, 5-10, 10-20, or 20-50 hours after the first time; a period ending at about 3 days after the first time; or a period ending at 1-2, 2-4, 4-8, or 8-16 days after the first time.

The probability measure can be a probability (e.g. “there is a 10% chance of an earthquake”), an areal probability density (e.g. “the earthquake probability has increased to 2% per million square miles”), a temporal probability density (e.g. “the earthquake probability has increased to 1.5% per day”), a linear probability density (e.g. “the earthquake probability density is 2% per 100 miles of the fault line”), and/or a probability density per amplitude measure (e.g. “the probability of an earthquake of magnitude between 5.0M and 6.0M is 3%, between 6.0M and 7.0M is 2%, and above 7.0 is 1%”). The probability measure can be a relative risk or a quantity derived from relative risk such as a relative risk density. The probability can be provided over a closed or open-ended range of magnitudes (or, other amplitude measure). Additionally, any combination of the above normalizations can be applied, such as probability per area per time per magnitude. Additionally, the probability measure can be stated as an absolute number (e.g. the examples immediately above) or as a relative number (e.g. “the probability density has increased by a factor of 2.3 compared to before the primary earthquake”).

In embodiments, the probability measure can be determined using a formula. For example, the probability measure can be determined from a knowledge of the baseline rate for the second spatial area, combined with a formula similar to G(θ) described above for the risk enhancement. In embodiments, the formula can be dependent on one or more of the following, in any combination: a baseline probability measure dependent on the first location; a spatial distance between the first location and the second spatial area; a time difference between the first time and a reference time of the second time window; a magnitude of the primary earthquake; a type of the primary earthquake (e.g. deep-focus, medium-focus, shallow-focus, interplate, or intraplate); a type of fault at the location of the primary earthquake (e.g. normal, reverse (thrust), or strike-slip); a number of foreshocks of the primary earthquake; a number of aftershocks of the primary earthquake; a magnitude (or, other amplitude measure) of the follow-on earthquake; an indicator of seismic susceptibility at the second spatial area; and/or an indicator of seismic cycle position at the second spatial area.

At process block 730, an earthquake alert is generated. In examples, the earthquake alert can include one or more of an audible alert (e.g. a bell, alarm, or siren), a visual alert (e.g. a flashing light, a beacon, an illuminated sign, or a pop-up message), or a message (e.g. a text message, an instant message, an email, or an emergency interrupt message).

At process block 740, the earthquake alert is transmitted to a destination. In embodiments, the earthquake alert can be transmitted over one or more of: a dedicated communication network (e.g. a VPN or leased line), a public communication network (e.g. a telephone or telex network), email, instant messaging, a publish-subscribe message service, or the Internet. In embodiments, the destination can be one or more of: a display (e.g. a computer monitor), a website (e.g. an earthquake news site, a news site, a private website, or a message board), a messaging service, an Internet service, an alarm service (e.g. a subscription-based alarm reporting service), a monitoring service (e.g. a sensor network host), a news organization, a security organization (e.g. a police or military department), or a governmental organization (e.g. a civil defense agency or fire department). The earthquake alert can be stored in a database, a log file, or another repository using a non-transitory storage medium, for archiving, remote access over a network, or future retrieval.

Additionally or alternatively to generating alerts, earthquake risks calculated after the primary earthquake can be applied to update an earthquake risk map, showing increases or absolute values of risk levels, including in real time. The updated earthquake risk map can be made available on the internet, through print media, or transmitted electronically to subscribers.

In embodiments, the earthquake alerts or risk assessments can incorporate additional factors, such as the location of faults within particular spatial zones, the seismic history of these faults, or the location of population centers within spatial zones. For example, the earthquake alerts or risks can be localized to areas of known faults, and can be increased if a fault is near the end of its seismic cycle (and hence has a large amount of stored energy which could relatively easily set off a follow-on earthquake with a small trigger), or attenuated if the fault is far from the end of its seismic cycle (and hence has only a small amount of stored energy). In embodiments, increased risks associated with a submarine fault can be propagated to geographic areas that could be at risk of tsunami damage from a follow-on earthquake on the submarine fault. Risk maps can also incorporate such additional features.

The amount of stored energy in a fault is related to its propensity to be released in an earthquake. Particularly, where stored energies are higher (later in the seismic cycle), the risk enhancement can be considerably greater, 1.5-2×, 2-3×, 3-5×, 5-10×, or higher compared to the average enhancement of risk. Additionally, the predictive ability of the disclosed technology can be higher at such times.

Earthquake alerts provide information that can be used by people, organizations, and machines to take preventive measures. People, events, or goods can be moved from high-risk locations to more stable locations, or movement to a high-risk location can be deferred until a time window of elevated risk has passed. High-risk locations can include atop or inside unsafe structures, or near a coastline where tsunami risk is present. Furniture and other structures can be secured against shaking, sliding, or other forms of earthquake damage. Water can be released from reservoirs to protect associated dams and downstream settlements.

### IV. System for Providing Earthquake Alerts

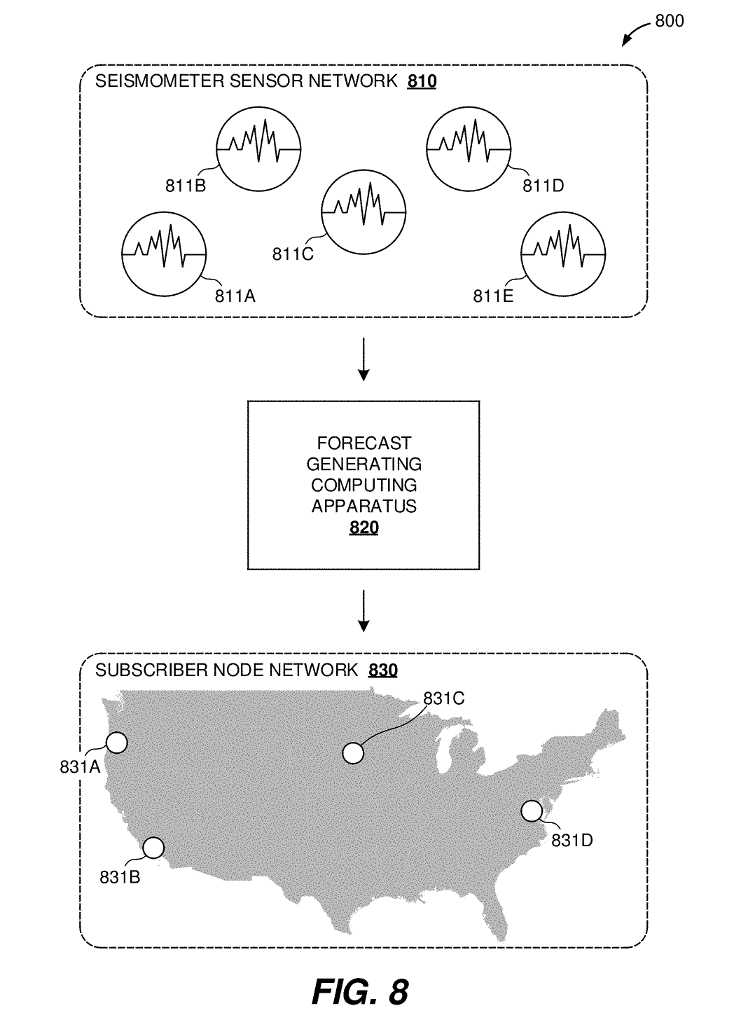

FIG. 8 is a diagram depicting an exemplary system 800 for generating and disseminating earthquake alerts according to the disclosed technology. The system 800 comprises one or more reporting sensors 811A-811E, a computing apparatus 820, and one or more subscriber nodes 831A-831D. In embodiments, the seismometer sensors 811A-811E are part of a sensor network 810, and/or the subscriber nodes 831A-831D are part of a subscriber network 830. The seismometer sensors 811A-811E are configured to report seismic activity, which can be as a data stream of a continuous seismometer signal or in the form of messages pertaining to discrete seismic events. The computing apparatus 820 includes one or more processors, with attached memory, and one or more network ports, and can also include other peripherals and devices as are known in the art or described further herein. The computing apparatus 820 is configured to receive seismic information from the seismometer sensors 811A-811E over one or more networks, to perform one or more of the methods disclosed herein, and to transmit earthquake alerts to the subscriber nodes 831A-831D over one or more networks. A subscriber node is a computing device configured to receive an earthquake alert, and can be associated with a government or news dissemination entity, or with any other destination described herein. The networks can be of any type as are known in the art or described herein.

### V. A Generalized Computer Environment

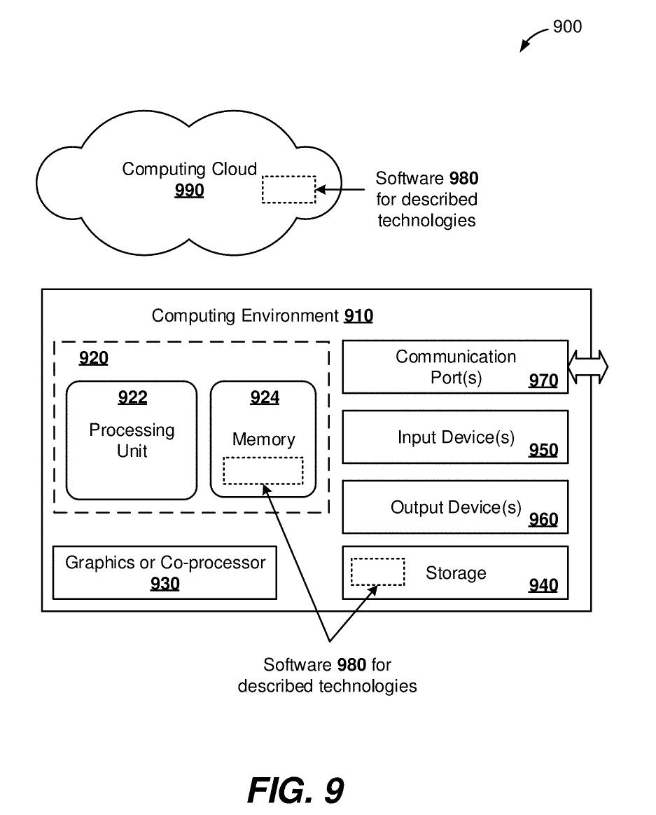

FIG. 9 illustrates a generalized example of a suitable computing system 900 in which described examples, techniques, and technology, including determining earthquake risk, forecasting earthquakes, or generating and transmitting earthquake alerts, can be implemented. The computing system 900 is not intended to suggest any limitation as to scope of use or functionality of the present disclosure, as the innovations can be implemented in diverse general-purpose or special-purpose computing systems. For example, the computing system 900 can be used to implement methods for determining associations between primary and follow-on events, for determining probability measures for follow-on earthquake events, for generating and transmitting earthquake alerts, and/or for updating or maintaining a risk map. The computing system 900 can receive seismometer data and can output forecasts, earthquake probability measures or alerts to subscribers or other destinations.

With reference to FIG. 9, computing environment 910 includes one or more processing units 922 and memory 924. In FIG. 9, this basic configuration 920 is included within a dashed line. Processing unit 922 executes computer-executable instructions, such as for any of the methods or functions described herein. Processing unit 922 can be a general-purpose central processing unit (CPU), processor in an application-specific integrated circuit (ASIC), or any other type of processor. In a multi-processing system, multiple processing units execute computer-executable instructions to increase processing power. Computing environment 910 can also include a graphics processing unit or co-processing unit 930. Tangible memory 924 can be volatile memory (e.g., registers, cache, or RAM), non-volatile memory (e.g., ROM, EEPROM, or flash memory), or some combination thereof, accessible by processing units 922, 930. The memory 924 stores software 980 implementing one or more innovations described herein, in the form of computer-executable instructions suitable for execution by the processing unit(s) 922, 930. The memory 924 can also store database data, including some or all of solid model data and material properties. The memory 924 can also store some or all of simulation data, and other configuration and operational data.

A computing system 910 can have additional features, such as one or more of storage 940, input devices 950, output devices 960, or communication ports 970. An interconnection mechanism (not shown) such as a bus, controller, or network interconnects the components of the computing environment 910. Typically, operating system software (not shown) provides an operating environment for other software executing in the computing environment 910, and coordinates activities of the components of the computing environment 910.

The tangible storage 940 can be removable or non-removable, and includes magnetic disks, magnetic tapes or cassettes, CD-ROMs, DVDs, or any other medium which can be used to store information in a non-transitory way and which can be accessed within the computing environment 910. The storage 940 stores instructions of the software 980 (including instructions and/or data) implementing one or more innovations described herein.

The input device(s) 950 can be a mechanical, touch-sensing, or proximity-sensing input device such as a keyboard, mouse, pen, touchscreen, or trackball, a voice input device, a scanning device, or another device that provides input to the computing environment 910. The output device(s) 960 can be a display, printer, speaker, optical disk writer, or another device that provides output from the computing environment 910.

The communication port(s) 970 enable communication over a communication medium to another computing entity. The communication medium conveys information such as computer-executable instructions, audio or video input or output, or other data in a modulated data signal. A modulated data signal is a signal that has one or more of its characteristics set or changed in such a manner as to encode information in the signal. By way of example, and not limitation, communication media can use an electrical, optical, RF, acoustic, or other carrier.

In some examples, computer system 900 can also include a computing cloud 990 in which instructions implementing all or a portion of the disclosed technology are executed. Any combination of memory 924, storage 940, and computing cloud 990 can be used to store software instructions and data of the disclosed technology.

The present innovations can be described in the general context of computer-executable instructions, such as those included in program modules, being executed in a computing system on a target real or virtual processor. Generally, program modules or components include routines, programs, libraries, objects, classes, components, data structures, etc. that perform particular tasks or implement particular abstract data types. The functionality of the program modules can be combined or split between program modules as desired in various embodiments. Computer-executable instructions for program modules can be executed within a local or distributed computing system.

The terms “system,” “environment,” and “device” are used interchangeably herein. Unless the context clearly indicates otherwise, neither term implies any limitation on a type of computing system, computing environment, or computing device. In general, a computing system, computing environment, or computing device can be local or distributed, and can include any combination of special-purpose hardware and/or general-purpose hardware and/or virtualized hardware, together with software implementing the functionality described herein.

### VI. General Considerations

As used herein, “comprising” means “including” and the singular forms “a” or “an” or “the” include plural references unless the context clearly dictates otherwise. The term “or” refers to a single element of stated alternative elements or a combination of two or more elements, unless the context clearly indicates otherwise.

Unless otherwise indicated, all numbers expressing areas, times, amplitude measures of earthquakes, p-values or other statistical measures, counts or rates of earthquake events, and so forth, as used in the specification or claims are to be understood as being modified by the term “about.” Accordingly, unless otherwise indicated, implicitly or explicitly, the numerical parameters set forth are approximations that may depend on the datasets used, testing or analysis procedures or parameters used, and other variations that can occur between one embodiment and another. When directly and explicitly distinguishing embodiments from discussed prior art, the embodiment numbers are not approximates unless the word “about” is recited. Unless indicated otherwise, all ranges are inclusive of both endpoints, but also include the ranges exclusive of one or both endpoints within their scope.

The systems, methods, and apparatus described herein should not be construed as being limiting in any way. Instead, this disclosure is directed toward all novel and non-obvious features and aspects of the various disclosed embodiments, alone and in various combinations and subcombinations with one another. The disclosed systems, methods, and apparatus are not limited to any specific aspect or feature or combinations thereof, nor do the disclosed things and methods require that any one or more specific advantages be present or problems be solved. Furthermore, any features or aspects of the disclosed embodiments can be used in various combinations and subcombinations with one another.

Although the operations of some of the disclosed methods are described in a particular, sequential order for convenient presentation, it should be understood that this manner of description encompasses rearrangement, unless a particular ordering is required by specific language set forth below. For example, operations described sequentially can in some cases be rearranged or performed concurrently. Moreover, for the sake of simplicity, the attached figures may not show the various ways in which the disclosed things and methods can be used in conjunction with other things and methods. Additionally, the description sometimes uses terms like “accept,” “analyze,” “apply,” “assign,” “bin,” “broaden,” “classify,” “communicate,” “compare,” “construct,” “define,” “demonstrate,” “determine,” “display,” “disseminate,” “distribute,” “estimate,” “evaluate,” “examine,” “filter,” “fit,” “flash,” “follow,” “forecast,” “generate,” “identify,” “indicate,” “maintain,” “message,” “monitor,” “normalize,” “omit,” “perform,” “predict,” “produce,” “provide,” “publish,” “receive,” “reject,” “report,” “return,” “subscribe,” “update,” and “use” to describe computer operations in a computer system. These terms are high-level abstractions of the actual operations that are performed by a computer. The actual operations that correspond to these terms will vary depending on the particular implementation and are readily discernible by one of ordinary skill in the art.

Theories of operation, scientific principles, or other theoretical descriptions presented herein in reference to the apparatus or methods of this disclosure have been provided for the purposes of better understanding and are not intended to be limiting in scope. The apparatus and methods in the appended claims are not limited to those apparatus and methods that function in the manner described by such theories of operation.

Any of the disclosed methods can be implemented as computer-executable instructions or a computer program product stored on one or more computer-readable storage media, such as tangible, non-transitory computer-readable storage media, and executed on a computing device (e.g., any available computing device, including tablets, smart phones, or other mobile devices that include computing hardware). Tangible computer-readable storage media are any available tangible media that can be accessed within a computing environment (e.g., one or more optical media discs such as DVD or CD, volatile memory components (such as DRAM or SRAM), or nonvolatile memory components (such as flash memory or hard drives)). By way of example, and with reference to FIG. 9, computer-readable storage media include memory 924, and storage 940. The term computer-readable storage media does not include signals and carrier waves. In addition, the term computer-readable storage media does not include communication ports (e.g., 970).

Any of the computer-executable instructions for implementing the disclosed techniques as well as any data created and used during implementation of the disclosed embodiments can be stored on one or more computer-readable storage media. The computer-executable instructions can be part of, for example, a dedicated software application or a software application that is accessed or downloaded via a web browser or other software application (such as a remote computing application). Such software can be executed, for example, on a single local computer (e.g., any suitable commercially available computer) or in a network environment (e.g., via the Internet, a wide-area network, a local-area network, a client-server network, a cloud computing network, or other such network) using one or more network computers.

For clarity, only certain selected aspects of the software-based implementations are described. Other details that are well known in the art are omitted. For example, it should be understood that the disclosed technology is not limited to any specific computer language or program. For instance, the disclosed technology can be implemented by software written in ABAP, Adobe Flash, C, C++, C#, Curl, Dart, Fortran, Java, JavaScript, Julia, Lisp, Matlab, Octave, Perl, Python, R, Ruby, SAS, SPSS, SQL, WebAssembly, any derivatives thereof, or any other suitable programming language, or, in some examples, markup languages such as HTML or XML, or in any combination of suitable languages, libraries, and packages Likewise, the disclosed technology is not limited to any particular computer or type of hardware. Certain details of suitable computers and hardware are well known and need not be set forth in detail in this disclosure.

Furthermore, any of the software-based embodiments (comprising, for example, computer-executable instructions for causing a computer to perform any of the disclosed methods) can be uploaded, downloaded, or remotely accessed through a suitable communication means. Such suitable communication means include, for example, the Internet, the World Wide Web, an intranet, software applications, cable (including fiber optic cable), magnetic communications, electromagnetic communications (including RF, microwave, infrared, and optical communications), electronic communications, or other such communication means.

The disclosed methods, apparatus, and systems should not be construed as limiting in any way. Instead, the present disclosure is directed toward all novel and nonobvious features and aspects of the various disclosed embodiments, alone and in various combinations and subcombinations with one another. The disclosed methods, apparatus, and systems are not limited to any specific aspect or feature or combination thereof, nor do the disclosed embodiments require that any one or more specific advantages be present or problems be solved. The techniques from any example can be combined with the techniques described in any one or more of the other examples.

In view of the many possible embodiments to which the principles of the disclosed invention may be applied, it should be recognized that the illustrated embodiments are only preferred examples of the invention and should not be taken as limiting the scope of the invention. Rather, the scope of the invention is defined by the following claims. We therefore claim as our invention all that comes within the scope and spirit of these claims.

We claim:

1. A method for determining enhanced earthquake risk, comprising:
receiving a corpus of data describing earthquake events above a damage threshold;
identifying one or more patterns among the earthquake events;
determining an enhancement of risk within a given time window associated with an arbitrary earthquake event.

2. The method of claim 1, wherein the pattern is a statistical correlation that exceeds a predetermined significance level.

3. The method of claim 1, wherein the determined enhancement of risk is within a spatial zone.

4. The method of claim 3, wherein the spatial zone includes at least one point having a polar angle of 160° relative to a location of the arbitrary earthquake event.

5. The method of claim 3, wherein the determining comprises obtaining a rule that expresses a probability measure associated with the arbitrary earthquake event as a function of the spatial zone and the given time window.

6. A method for determining enhanced earthquake risk, comprising:
assigning a corpus of earthquake event data to respective space-time bins relative to test earthquake events;
determining observed event counts or rates in one or more spatial zones in a given time window;
determining baseline event rates in the one or more spatial zones outside the given time window; and
evaluating p-values for a null hypothesis from the observed event counts or rates and the baseline event rates;
wherein the given time window is relative to a time of each test earthquake event and the spatial zones are relative to a location of each earthquake event.

7. The method of claim 6, wherein the test earthquake events are candidate primary events and the given time window is after the time of each test earthquake event.

8. The method of claim 6, wherein the test earthquake events are candidate follow-on events and the given time window precedes the time of each test earthquake event.

9. The method of claim 6, wherein at least one of the spatial zones has a spatial extent comprising points on Earth's surface having an angular distance from the location of a corresponding test earthquake event that are in a range from a lower limit to an upper limit, wherein the lower and upper limits are independently in the range from 1°-180°, and the upper limit is greater than the lower limit.

10. The method of claim 6, wherein the given time window has a temporal extent before or after the time of a corresponding test earthquake event in a range between a near time offset and a far time offset, wherein the near time offset is in a range 0 to 48 hours, wherein the far time offset is in a range 5 hours to 10 days, and wherein the near time offset is less than the far time offset.

11. The method of claim 6, wherein a first one of the test earthquake events is a main event having a main event amplitude measure, and the test earthquake events are filtered by omitting or removing foreshock and aftershock earthquake events of the main event having respective amplitude measures less than the main event amplitude measure.

12. The method of claim 6, further comprising evaluating a risk enhancement factor for at least a given one of the spatial zones based at least partly on the observed event rate and the baseline event rate for the given spatial zone.

13. The method of claim 12, further comprising performing a fit to the evaluated risk enhancement factors as a function of spatial zone.

14. One or more computer-readable media storing instructions which, when executed by a hardware processor, cause the method of claim 6 to be performed.

15. A method for providing an earthquake alert, the method comprising:
receiving indication of a primary earthquake at a first location and at a first time;
based at least partly on the indication, determining a probability measure of a follow-on earthquake in a second spatial area and over a second time window; and
based at least partly on the probability measure, generating the earthquake alert for the second spatial area and the second time window.

16. The method of claim 15, wherein the second spatial area is outside an aftershock zone associated with the primary earthquake, and the second time window is outside an aftershock window associated with the primary earthquake.

17. The method of claim 15, wherein the determining is performed using a rule that is a function of:
a spatial distance between the first location and the second spatial area;
a time difference between the first time and a reference time of the second time window; and
a magnitude of the primary earthquake.

18. The method of claim 15, wherein the second spatial area comprises an area defined by a polar angle extent relative to a pole at the first location;

19. The method of claim 15, wherein the second spatial area comprises an area including at least one point having a polar angle of 160° relative to a pole at the first location.

20. A system for providing an earthquake alert, comprising:
one or more earthquake sensors;
a computing system comprising at least one hardware processor with memory coupled thereto, and one or more network connections;
wherein the computing system is configured to execute instructions to provide the earthquake alert according to claim 15; and
wherein the indication is received from at least a first one of the earthquake sensors via a first one of the network connections; and
one or more subscriber nodes configured to receive the earthquake alert via a second one of the network connections.
